(19) United States
(12) Patent Application Publication
(10) Pub. No.: US 2020/0156159 A1
(43) Pub. Date: May 21, 2020

(54) NOVEL DRILL CHUCK

(71) Applicant: ZHEJIANG SANOU MACHINERY CO. LTD., Luqiao Taizhou (CN)

(72) Inventor: Xiangyu LI, Luqiao Taizhou (CN)

(21) Appl. No.: 16/591,936

(22) Filed: Oct. 3, 2019

(30) Foreign Application Priority Data
Oct. 4, 2018 (CN) 201811164112.5

(51) Int. Cl. B23B 31/107

(52) U.S. Cl. CPC B23B 31/1071

(57) ABSTRACT

The present invention provide a novel drill chuck comprising a rotary sleeve, a drill body, a nut and a clamping jaw, wherein the nut is connected with the clamping jaw via threaded connection, the rotary sleeve is directly connected with or connected with the nut through a connecting structure, the drill body is provided with an inclined clamping jaw hole for the clamping jaw to slide back and forth along the clamping jaw hole, a ring of steel balls are cushioned around the drill body at the back of the nut; wherein a deformable and recoverable energy storage support structure is disposed between the nut and the drill body, for pushing the nut forward and increasing the threading force of the nut and the clamping jaw and providing cushioning to prevent loosening. The present invention has a simple structure, no matter for a common keyless drill chuck or a self-locking drill chuck, the present invention can cope with adverse effects on the clamping of drill bit and maintaining locking state of drill chuck generated by various reasons, significantly improve the performance of the drill chuck and prevent the occurrence of loosening during the drilling work.

### FIELD OF THE INVENTION

The present invention relates to a drill chuck, and more particularly to a keyless drill chuck.

### BACKGROUND OF THE INVENTION

A drill chuck has a drill body, a clamping jaw and a nut, the nut is connected with the clamping jaw via threaded connection. The keyless drill chuck is provided with a rotary sleeve, and the rotary sleeve is directly connected with or connected with the nut through a connecting structure. By manually operating the rotary sleeve and rotating the nut to drive the clamping jaw to move forwardly or backwardly, the drill bit is clamped or loosened by the clamping jaw. When the drill bit is clamped for drilling work in the actual use, there are a number of factors that may cause the nut to loosen reversely, eventually resulting in the loosening of the drill bit or failure of the locking state of the drill chuck.

### SUMMARY OF THE INVENTION

An object of the present invention is to provide a novel drill chuck capable of increasing the threading force of the nut and the clamping jaw and providing cushioning to prevent loosening. In order to achieve this object, the present invention adopts the following technical solutions:

A novel drill chuck, comprising a rotary sleeve, a drill body, a nut and a clamping jaw, wherein the nut is connected with the clamping jaw via threaded connection, the rotary sleeve is directly connected with or connected with the nut through a connecting structure, the drill body is provided with an inclined clamping jaw hole for the clamping jaw to slide back and forth along the clamping jaw hole, a ring of steel balls are cushioned around the drill body at the back of the nut; wherein a deformable and recoverable energy storage support structure is disposed between the nut and the drill body, for pushing the nut forward and increasing the threading force of the nut and the clamping jaw and providing cushioning to prevent loosening.

Further, a metal washer is disposed at the rear of the ring of steel balls, and the energy storage support structure comprises the metal washer, the metal washer is provided with a support surface and a forward curved portion that are engaged with a support structure at the rear thereof, the forward curved portion comprises a steel ball support portion, and the ring of steel balls is cushioned on the steel ball support portion.

Further, the forward curved steel ball support portion is on the periphery of the support surface.

Further, the support surface mates with the middle step of the drill body.

Further, at least most of the forward curved portion is overhung on the drill body.

Further, the metal washer is fixedly connected with the drill body.

Further, a metal ring is provided between the ring of steel balls and the nut, the energy storage support structure comprises the metal ring, the metal ring is provided with a support surface supporting the nut and a rearward curved portion, the rearward curved portion comprises a steel ball action portion, and the ring of steel balls mate with and support the steel ball action portion.

Further, the rearward curved steel ball support portion is on the periphery of the support surface.

Further, the support surface mates with a rear end surface of the nut.

With the technical solutions herein, the present invention has a simple structure, no matter for a common keyless drill chuck or a self-locking drill chuck, the present invention can cope with adverse effects on the clamping of drill bit and maintaining locking state of drill chuck generated by various reasons, significantly improve the performance of the drill chuck and prevent the occurrence of loosening during the drilling work.

### BRIEF DESCRIPTION OF THE DRAWINGS

FIG. 1 is a cross-sectional view according to Example 1 of the present invention.

FIG. 2 is an exploded view according to Example 1 of the present invention.

FIG. 3 is a front view according to Example 1 of the present invention.

FIG. 4 is a perspective view according to Example 1 of the present invention.

FIG. 5 is a schematic view showing the supporting and mating of a washer with steel balls according to Example 1 of the present invention.

FIG. 6 is a schematic view showing the supporting and mating of a washer with steel balls in another mode of execution according to Example 1 of the present invention.

FIG. 7 is a cross-sectional view according to Example 2 of the present invention.

FIG. 8 is a perspective view of a washer according to Example 2 of the present invention.

FIG. 9 is a schematic view showing the supporting and mating of a metal ring with steel balls according to Example 2 of the present invention.

FIG. 10 is a cross-sectional view according to Example 3 of the present invention.

FIG. 11 is a cross-sectional view according to Example 4 of the present invention.

FIG. 12 is a cross-sectional view according to Example 5 of the present invention.

FIG. 13 is an exploded view according to Example 5 of the present invention.

### DETAILED DESCRIPTION OF THE EMBODIMENTS

### Example 1

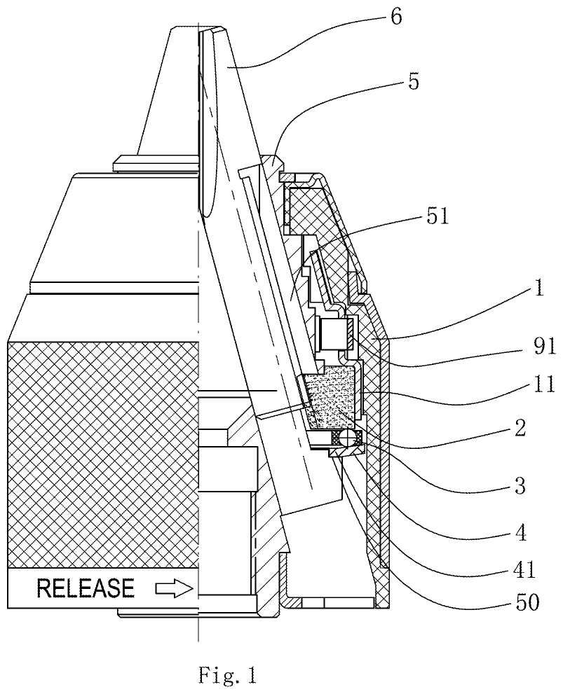

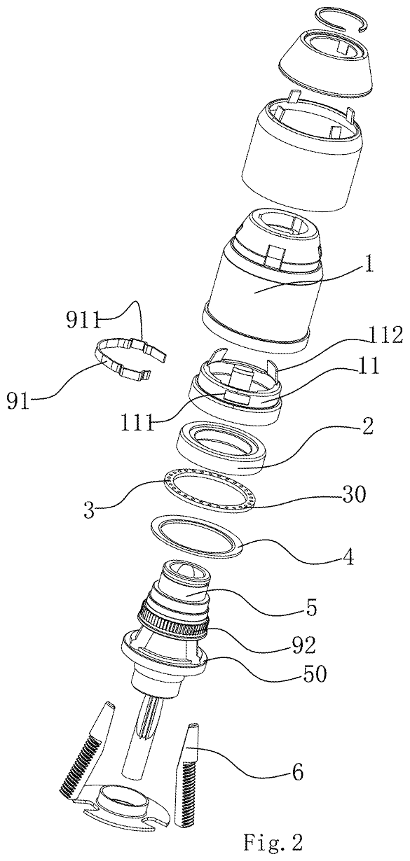

Referring to FIG. 1 and FIG. 2, the drill chuck provided herein, comprising a rotary sleeve 1, a drill body 5, a nut 2 and three clamping jaws 6, wherein the nut 2 is connected with the three clamping jaws 6 via threaded connection. The drill body 5 is provided with an inclined clamping hole 51, and the clamping jaw 6 passes through the clamping jaw hole 51 and can slide back and forth along the clamping jaw hole 51 driven by the nut 2. At the rear of the nut 2, a ring of steel balls 3 are cushioned around the drill body 5, the drill body 5 is provided with a middle step 50, and a metal washer 4 is provided on the middle step, all of which constitute a support structure behind the steel balls.

The ring of steel balls 3 may be combined with the bearing frame 30 into a bearing component or may not be provided with a ring frame 30. The steel ball 3 can wrap the grease for bearings.

In this embodiment, the drill chuck is further provided with a self-locking structure. The self-locking structure adopts a spring piece 91 and a gear ring 92 that mates with the locking end of the spring piece 91. The ring gear 92 can be disposed on the drill body 5. The nut is externally connected with a metal sleeve 11. The metal sleeve 11 extends a connecting portion at the front portion thereof, and the connecting portion includes a hole 111 connected to the spring piece and a groove 112 (or a key) connected to the rotary sleeve, and the spring piece is connected to the hole 111 by a middle convex portion thereof. The inside of the rotary sleeve has a cam surface that is in engagement with the spring piece to control the insertion of the spring piece locking end into the ring gear 92 to cause the drill chuck to enter the self-locking state and to disengage the ring gear, such that the drill chuck enters the unlocked state. There is a first connecting groove connected with the middle convex portion 911 of the spring piece in the unlocked state and a second groove connected with the middle convex portion 911 of the spring piece in the self locking state in the inner wall of the rotary sleeve. There is a key (or groove) that is in engagement with the groove 112 (or the key) in the inner wall of the rotary sleeve, and such engagement is an intermittent engagement of transposition, that is, when the drill chuck is stored in the unlocked state, the rotary sleeve 1 drives the nut 2 to rotate through the connection relationships between the first connecting groove and the middle convex portion 911, between the spring piece 91 and the metal sleeve 11, between the metal sleeve 11 and nut 2, and the nut drives the three clamping jaws 6 to move forward along the clamping jaw hole to clamp the drill bit. When the drill chuck enters the self locking state, the rotary sleeve 1 rotates at an angle with respect to the metal sleeve 11. At this time, the groove wall (or key) of the groove 112 is in contact with the key (or the groove wall of the groove) of the inner wall of the rotary sleeve which is engaged with the groove 112 (or the key) in the direction of rotation, and the connection relationship drives the nut 2 to rotate, and at this time, the connection relationship between the first connecting groove of the rotary sleeve and the bulge in the middle of the spring piece is switched to the connection relationship between the second connecting groove and the bulge in the middle of the spring piece, to form a state locking function of maintaining the self-locking state when the drill chuck is working.

The above only exemplifies a self-locking structure of the drill chuck. The self-locking structure of the drill chuck may have other settings, for example, the gear ring 92 can be disposed on a part or a portion that is fixedly connected to the drill body 5 such as a sleeve body. The position of the spring piece 91 can be changed; unlike this embodiment, the middle portion of the drill body is not provided with a nut groove, but provided with a fixing sleeve in front of the drill body, and the fixing sleeve mates with the step 50 in the middle of the drill body to restrict the nut 2.

The drill chuck is provided with an energy storage support structure that can be deformed and restored between the nut and the drill body. At the beginning of rotating the nut to drive the clamping jaw to clamp the drill bit, the energy storage support structure is in an initial state, and operators can rotate the nut easily.

Preferably, the energy storage support structure adopts the foregoing metal washer 4, and the metal washer 4 is preferably connected to the drill body fixedly, and cannot be relatively rotated. The metal washer 4 is provided with a support surface 41 mating with the middle step of a drill body 50. The forward curved portion 40 is provided on the periphery of the support surface 41, and the forward curved portion includes a steel ball support portion 42, the ring of steel balls 3 is cushioned on the steel ball support portion 42. The forward curved portion 40 may be bent into a slope as shown in FIG. 5 of the embodiment, or bent into a curved surface as in FIG. 6, and the steel balls are supported on the slope or the curved surface. Or the forward curved portion 40 is bent again, and the steel ball support portion is at the re-bent portion.

More preferably, the metal wash 4 has a diameter larger than the maximum diameter of the drill body, such that at least most of the forward curved portion is overhung on the drill body.

The energy storage support structure uses a forward curved part of the forward curved portion as the energy storage portion. The drill chuck continue to rotate the nut 2 after clamping the drill bit in the direction of driving the clamping jaw to move forwardly, the nut 2 is subjected to a push-back force to compress the energy storage part of the energy storage support structure to transform and store energy, and convert into potential energy to react forward, improving the engaging force of the nut and the clamping jaw. During working, the push-back force acting on the nut will be stored by the energy storage part to convert into a potential energy for improving the engaging force of the nut and the clamping jaw; and when impacted, it can also act as a buffer to avoid generating a relative displacement or self-locking failure between the nut and the clamping jaw in the direction of loosening the drill bit, and prevent loosening.

When the drill chuck stops drilling and the push-back force acting on the nut disappears, the forward curved portion will automatically return to the initial state.

### Example 2

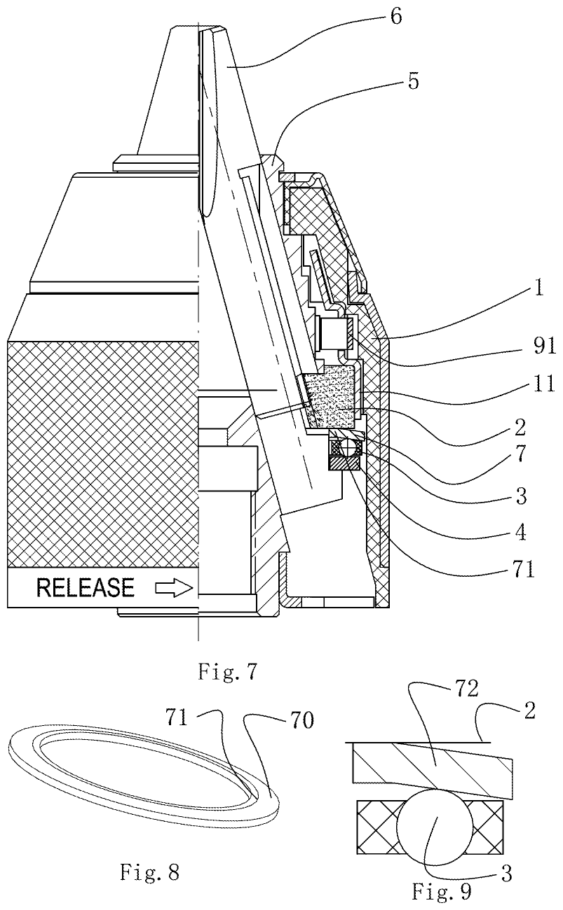

Referring to FIGS. 7, 8, 9, in this embodiment, the metal washer 4 is not provided as the energy storage support structure, and a metal ring 7 is disposed between the ring of steel balls 3 and the nut 2, and the energy storage support structure 7 includes the metal ring 7 which is provided with a support surface 71 that supports the nut and a rearward curved portion 70. The rearward curved portion 70 includes a steel ball action portion 72, and the ring of steel balls 3 mate with and support the steel ball action portion 72.

The rearward curved portion may be bent into a slope or a curved surface as shown in the figures of this embodiment, and the steel balls are supported on the slope or the curved surface. Or the rearward curved portion is bent again, and the steel ball action portion is at the re-bent portion.

The energy storage support structure uses a rearward curved part of the rearward curved portion as the energy storage portion. The drill chuck continue to rotate the nut 2 after clamping the drill bit in the direction of driving the clamping jaw to move forwardly, the nut 2 is subjected to a push-back force to compress the energy storage part of the energy storage support structure to transform and store energy, and convert into potential energy to react forward, improving the engaging force of the nut and the clamping jaw. During working, the push-back force acting on the nut will be stored by the energy storage part to convert into a potential energy for improving the engaging force of the nut and the clamping jaw; and when impacted, it can also act as a buffer to avoid generating a relative displacement or self-locking failure between the nut and the clamping jaw in the direction of loosening the drill bit, and prevent loosening.

When the drill chuck stops drilling and the push-back force acting on the nut disappears, the forward curved portion will automatically return to the initial state.

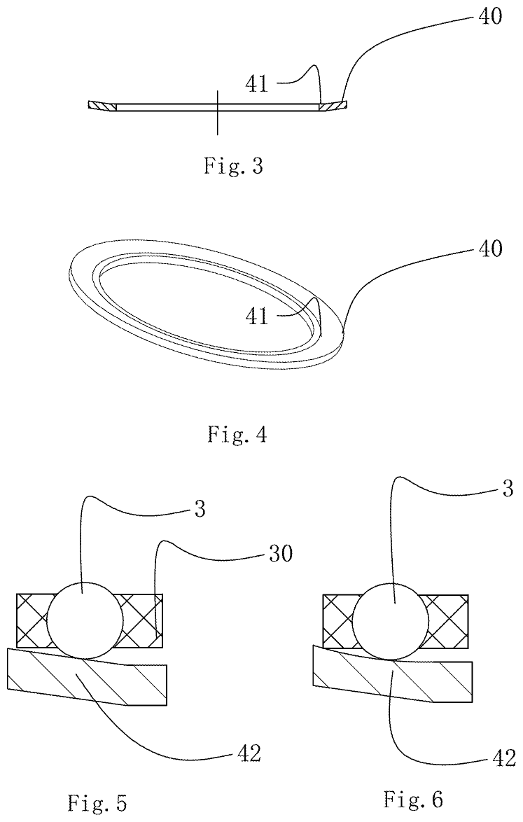

The other structures of this embodiment are the same as those of Example 1. In FIGS. 7 to 9, the components same as those in Example 1 are given the same reference numerals as those in FIGS. 1 to 6, which are not described again herein.

### Example 3

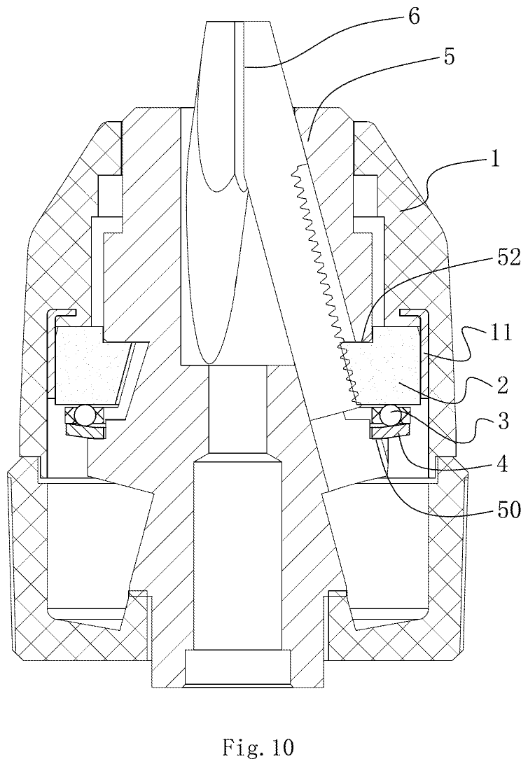

Referring to FIG. 10, in this embodiment, the self-locking structure in Examples 1 and 2 is not provided. The metal sleeve 11 as a nut sleeve is inlaid in the rotary sleeve 1, the metal sleeve 11 is wrapped outside the rotary sleeve 1 and is connected with the nut 2 by interference fit. The metal sleeve 11 may not be inlaid in the rotary sleeve 1 and is connected with the rotary sleeve 1 through a connection relationship such as engagement of keyway, etc. The nut 2 is composed of two halves. When mounting, the two halves are first placed in a nut groove on the drill body, and then the two halves are connected to the entire nut 2 through the metal sleeve 11. The nut groove is constituted by a middle step 50 and a front groove wall 52 on the drill body 5, and the front groove wall 52 has a limiting effect in the front of the nut 2.

In this embodiment, the energy storage support structure uses the structure of Example 1. The energy storage support structure uses a forward curved part of the forward curved portion as the energy storage portion. The drill chuck continue to rotate the nut 2 after clamping the drill bit in the direction of driving the clamping jaw to move forwardly, the nut 2 is subjected to a push-back force to compress the energy storage part of the energy storage support structure to transform and store energy, and convert into potential energy to react forward, improving the engaging force of the nut and the clamping jaw. During working, the push-back force acting on the nut will be stored by the energy storage part to convert into a potential energy for improving the engaging force of the nut and the clamping jaw; and when impacted, it can also act as a buffer to avoid generating a relative displacement or self-locking failure between the nut and the clamping jaw in the direction of loosening the drill bit, and prevent loosening.

When the drill chuck stops drilling and the push-back force acting on the nut disappears, the forward curved portion will automatically return to the initial state.

The other structures of this embodiment are the same as those of Example 1. In FIGS. 7 to 9, the components same as those in Example 1 are given the same reference numerals as those in FIGS. 1 to 6, which are not described again herein.

### Example 4

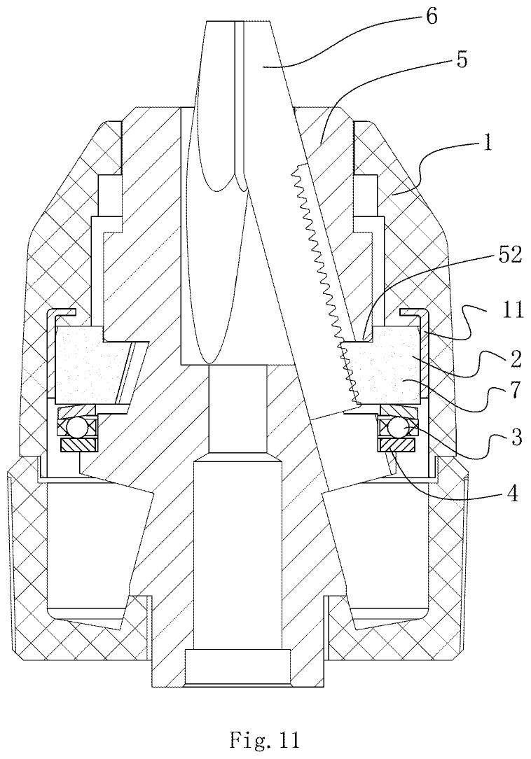

Referring to FIG. 11, in this embodiment, the energy storage support structure uses the structure of Example 2. The others are the same as those in Example 3. In FIG. 11, the components same as those in Examples 2 and 3 are given the same reference numerals as those in FIGS. 1 to 10, which are not described again herein.

### Example 5

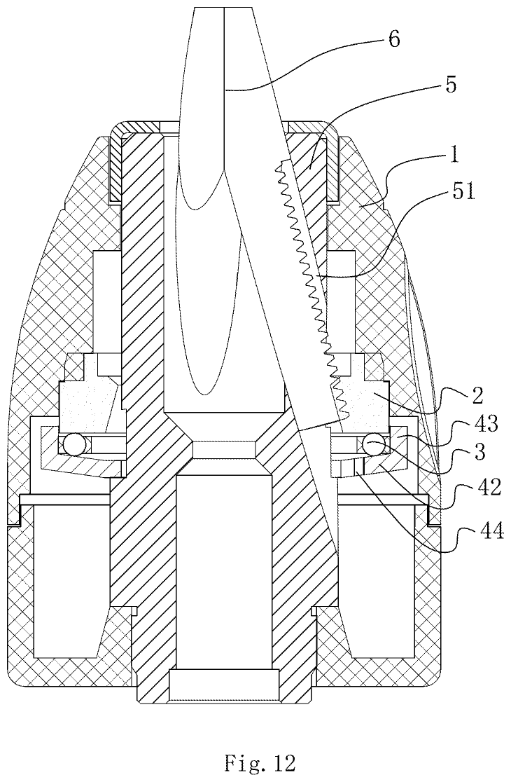

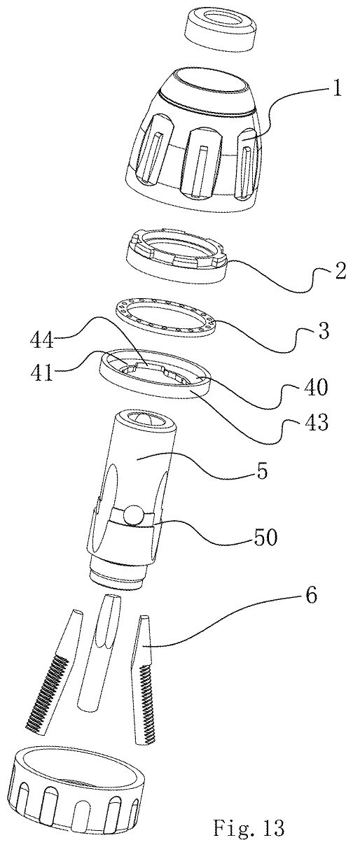

Referring to FIGS. 12, 13, similar to Examples 3 and 4, no self-locking structure is provided in this embodiment. Different from Examples 3 and 4, the drill body 5 of this embodiment is not provided with the front groove wall 52, and the nut 2 is no longer a component of the split combination but is integral itself. When mounting, the nut 2 is directly sleeved outside of the drill body, and the component such as the sleeve or the rotary sleeve that is fixed on the front of the drill body 5 has a limiting role in the front of the nut 2. In this embodiment, the front of the nut is limited by the rotary sleeve 1. The rotary sleeve 1 drives the nut 2 to rotate through engagement of keyway.

The energy storage support structure of this embodiment basically adopts the structure of Examples 1 and 3, that is, the metal washer 4 is provided with a support surface 41 mating with the middle step of a drill body 50. The forward curved portion 40 is provided on the periphery of the support surface 41, and the forward curved portion includes a steel ball support portion 42, the ring of steel balls 3 is cushioned on the steel ball support portion 42. Further, on the outer side of the forward curved portion, an accessory structure of the metal washer 4 is provided, which is a vertically bent nut positioning sleeve 43, and the nut positioning sleeve 43 serves as a central positioning aid for the nut 2. In addition, a clamping jaw retaining groove 44 extending from the clamping jaw hole 50 is disposed inside the support surface 41 on the washer 4.

The other structures of this embodiment are the same as those of Examples 1 and 3. In FIG. 11, the components same as those in Examples 1 and 3 are given the same reference numerals as those in FIGS. 1 to 10, which are not described again herein.

The foregoing description is merely the specific embodiments of the present invention, but the structural features of the present invention are not limited thereto, and any changes or modifications made by those skilled in the art within the scope of the present invention fall into the scope of protection of the present invention.

1. A novel drill chuck, comprising a rotary sleeve, a drill body, a nut and a clamping jaw, wherein the nut is connected with the clamping jaw via threaded connection, the rotary sleeve is directly connected with or connected with the nut through a connecting structure, the drill body is provided with an inclined clamping jaw hole for the clamping jaw to slide back and forth along the clamping jaw hole, a ring of steel balls are cushioned around the drill body at the back of the nut; wherein a deformable and recoverable energy storage support structure is disposed between the nut and the drill body, for pushing the nut forward and increasing the threading force of the nut and the clamping jaw and providing cushioning to prevent loosening.

2. The novel drill chuck according to claim 1, wherein a metal washer is disposed at the rear of the ring of steel balls, and the energy storage support structure comprises the metal washer, the metal washer is provided with a support surface and a forward curved portion that are engaged with a support structure at the rear thereof, the forward curved portion comprises a steel ball support portion, and the ring of steel balls is cushioned on the steel ball support portion.

3. The novel drill chuck according to claim 2, wherein the forward curved steel ball support portion is on the periphery of the support surface.

4. The novel drill chuck according to claim 2, wherein the support surface mates with the middle step of the drill body.

5. The novel drill chuck according to claim 2, wherein at least most of the forward curved portion is overhung on the drill body.

5. The novel drill chuck according to claim 2, wherein the metal washer is fixedly connected with the drill body.

6. The novel drill chuck according to claim 1, wherein a metal ring is provided between the ring of steel balls and the nut, the energy storage support structure comprises the metal ring, the metal ring is provided with a support surface supporting the nut and a rearward curved portion, the rearward curved portion comprises a steel ball action portion, and the ring of steel balls mate with and support the steel ball action portion.

7. The novel drill chuck according to claim 6, wherein the rearward curved steel ball support portion is on the periphery of the support surface.

8. The novel drill chuck according to claim 6, wherein the support surface mates with a rear end surface of the nut.
